(19) United States
(12) Patent Application Publication
(10) Pub. No.: US 2008/0286551 A1
(43) Pub. Date: Nov. 20, 2008

(54) PLASTIC-CELLULOSIC COMPOSITE ARTICLES

(75) Inventor: Stephen Michalik, Beaver, PA (US)

Correspondence Address: NOVA Chemicals Inc., Westpointe Center, 1550 Coraopolis Heights Road, Moon Township, PA, 15108, US

(73) Assignee: NOVA CHEMICALS INC., Moon Township, PA (US)

(21) Appl. No.: 12/120,300

(22) Filed: May 14, 2008

Related U.S. Application Data
(60) Provisional application No. 60/930,441, filed on May 16, 2007.
(60) Provisional application No. 61/020,487, filed on Jan. 11, 2008.

(51) Int. Cl. B32B 27/06; C08G 63/91

(52) U.S. Cl. 428/220; 525/54.21

(57) ABSTRACT

Articles containing a cellulosic fiber filled thermoplastic that includes about 10% to about 99.9% by weight of a copolymer; optionally 0.1% to 30% by weight of one or more elastomeric polymers; and 0.1% to 70% by weight of one or more cellulosic fibers. The copolymer contains residues formed by polymerizing a mixture that contains i) 51% to 99.9% by weight of one or more primary monomers, ii) 0.1% to 49% by weight of one or more maleate-type monomers, and iii) optionally 1% to 25% by weight of one or more other polymerizable monomers. The article has a thickness of from 0.1 cm to 12 cm. The tensile modulus, determined according to ISO 527-2, of the cellulosic fiber filled thermoplastic is at least 2,000 MPa and the DTUL at 1.82 MPa determined according to ISO-75-2, of the cellulosic fiber filled thermoplastic can be at least 85° C.

### REFERENCE TO RELATED APPLICATION

This application claims the benefit of priority of U.S. Provisional Application Ser. Nos. 61/020,487 filed Jan. 11, 2008 entitled “Plastic-Cellulosic Composite Articles” and 60/930,441 filed May 16, 2007 entitled “Plastic-Cellulosic Composite Articles,” which are both herein incorporated by reference in their entirety.

### BACKGROUND OF THE INVENTION

1. Field of the Invention

The present invention is directed to articles made from thermoplastic materials containing cellulosic fibers.

2. Description of the Prior Art

Traditionally, fences and decks have been made of components fashioned from solid wood. Wood fences and decks are often considered more aesthetically appealing than those made of metal or cement, for example, wire fences or cement block walls or decks. However, construction of a wood fence or a wood deck is labor intensive. Solid wood components can be heavy and cumbersome. In addition, maintenance of a wood fence or deck is expensive. After a period of time, solid wood fence and deck components will naturally begin to break down from weather exposure and pest infestations. It is known that this deterioration can be tempered by treating the fence or deck with widely available weather resistant coatings, paints, varnishes, finishes and the like. Unfortunately, however, it is often only a matter of time before such treated fences or decks deteriorate requiring partial or complete replacement. Many solid wood materials that are suitable for fencing or decking are costly. In addition, because of natural variations in wood, replacement of individual components may result in an inconsistent, uneven appearance to the fence or deck.

Many products, technologies and ideas have been used to make extruded or molded thermoplastics as an alternative to wood in semi-structural outdoor applications such as decking, park walkways, children's playgrounds, seats and benches. The thermoplastic most widely used is polyethylene, typically a recycled product from HDPE, LDPE & LLDPE milk bottles, film etc. Other thermoplastics widely used include PVC and polypropylene. Many systems also use a filler, typically wood or other natural fibers, compounded into the thermoplastic to enhance properties and make the compound look more like the wooden planks it replaces. These systems are rapidly gaining market acceptance, especially in decks where they have advantages of long-term durability and lack of maintenance. They have an additional advantage because of recent health concerns regarding the chemicals and preservatives used to treat wood for outdoor applications.

Many composites, such as cellulosic/polymer composites, are used as replacements for all-natural wood, particleboard, wafer board, and other similar material. For example, U.S. Pat. Nos. 3,908,902, 4,091,153, 4,686,251, 4,708,623, 5,002,713, 5,087,400, and 5,151,238 relate to processes for making wood replacement products. As compared to natural woods, cellulosic/polymer composites offer superior resistance to wear and tear. In particular, cellulosic/polymer composites have enhanced resistance to moisture. In fact, it is well known that the retention of moisture is a primary cause of the warping, splintering, and discoloration of natural woods. Moreover, cellulosic/polymer composites have the appearance of natural wood, and they may be sawed, sanded, shaped, turned, fastened, and finished in the same manner as natural woods. Consequently, cellulosic/polymer composites are commonly used for applications such as interior and exterior decorative house moldings, picture frames, furniture, porch decks, deck railings, window moldings, window components, door components, roofing structures, building siding, and other suitable indoor and outdoor components.

Those skilled in the art have recognized that excessive moisture content in a synthetic wood composition may result in a poor quality end product. In particular, excessive moisture content in a synthetic wood composition may result in an end component that is susceptible to cracking, blistering, and deteriorating appearance. Consequently, it may be necessary to dry any cellulosic material to a predetermined level prior to introducing it into the synthetic wood composition. Even after the cellulosic material is dried, it has a natural tendency to reabsorb moisture from the environment. As a result, it may also be necessary to store the dried cellulosic material in a moisture controlled environment in order to prevent the cellulosic material from reabsorbing additional moisture before being added to the synthetic wood composition. In light of these considerations, it may be difficult and costly to maintain sufficiently dry cellulosic material while shipping it between different locations.

Plastic fence components have been developed as alternatives or supplements to traditional, natural wood fences. For example, U.S. Pat. No. 5,100,109 describes a method of constructing a fence by providing a flexible, plastic, rollable fence board that can be unrolled and fastened to spaced apart fence posts. The flexible fence board is made with height and width dimensions simulating a standard wooden board and with a length of 350 feet or more. According to this patent, the fence board is formed in a continuous extrusion process of a flexible thermoplastic material.

U.S. Pat. No. 5,404,685, describes a wall or fence made in part of foamed polystyrene plastic components, more specifically, plastic columns and panels. Construction of a fence in accordance with this patent requires multiple steps. For example, wall or fence stability is achieved by pouring a reinforcing filler, such as concrete, into a hollow of the polystyrene plastic columns after the columns have been secured to the ground. A hardened outer surface of the fence is achieved by applying an exterior finish, such as stucco or special exterior paint, to the fence or wall after the fence has been constructed.

However, the synthetic wood or wood composite products described above, typically have disadvantages when their mechanical properties, especially strength and stiffness are compared with the wood they replace. Further, the wood/cellulosic composites described above are susceptible to creep when subjected to continuous loads and/or high ambient temperatures. Additionally, these materials tend to warp after long term exposure to heat. Because of these structural limitations the use of the synthetic wood products described above is often restricted to less structural applications. For example, in decks they are used for deck boards but typically cannot be used for the vertical posts and joists that bear the loads of the whole structure. Further, because the synthetic wood or wood composite products described above typically have a density greater than water, they are often not suitable for marine applications.

Thus, there is a need in the art for synthetic wood or wood composite products that overcome the deficiencies described above.

### SUMMARY OF THE INVENTION

The present invention is directed to articles that contain a cellulosic fiber filled thermoplastic that includes about 10% to about 99.9% by weight of a copolymer; optionally about 0.1% to about 30% by weight of one or more elastomeric polymers; and about 0.1% to about 70% by weight of one or more cellulosic fibers. The copolymer contains residues formed by polymerizing a mixture that contains i) about 51% to about 99.9% by weight of one or more primary monomers, ii) about 0.1% to about 49% by weight of one or more maleate-type monomers, and iii) optionally about 1% to about 25% by weight of one or more other polymerizable monomers. The article has a thickness of from about 0.1 cm to about 35 cm and at least a portion of the article is foamed.

The present invention also provides a method of making the above-described article that includes using the copolymer, optionally combined with one or more elastomeric polymers, to form a compounded copolymer by combining the cellulosic fibers with the copolymer and/or compounded copolymer to form a cellulosic compounded copolymer; and extruding the cellulosic compounded copolymer to form an extruded article.

The present invention is also directed to fences, decking systems, walls, roof systems, wall systems, floor systems, sheet products, slats for window blinds, structures, buildings, boardwalks, railings and sports boards that include the above-described article.

### DESCRIPTION OF THE DRAWINGS

FIG. 1 is a perspective view of an extruded article according to embodiments of the invention;

FIG. 2 is a cross-section at A-A of an end of an extruded article according to embodiments of the invention;

FIG. 3 is a perspective view of a board according to embodiments of the invention;

FIG. 4 is a perspective view of a fence according to embodiments of the invention;

FIG. 5 is a fragmentary, top perspective view, broken away in part, of a deck system constructed according to embodiments of the invention; and

FIG. 6 is a partial perspective view of a floor or wall arrangement using a panel according to the invention.

### DETAILED DESCRIPTION OF THE INVENTION

For the purpose of the description hereinafter, the terms “upper”, “lower”, “inner”, “outer”, “right”, “left”, “vertical”, “horizontal”, “top”, “bottom”, and derivatives thereof, shall relate to the invention as oriented in the drawing Figures. However, it is to be understood that the invention may assume alternate variations and step sequences except where expressly specified to the contrary. It is also to be understood that the specific devices and processes, illustrated in the attached drawings and described in the following specification, is an exemplary embodiment of the present invention. Hence, specific dimensions and other physical characteristics related to the embodiment disclosed herein are not to be considered as limiting the invention. In describing the embodiments of the present invention, reference will be made herein to the drawings in which like numerals refer to like features of the invention.

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, homopolymers, copolymers and graft copolymers.

Unless otherwise specified, all molecular weight values are determined using gel permeation chromatography (GPC) using appropriate polystyrene standards. Unless otherwise indicated, the molecular weight values indicated herein are weight average molecular weights (Mw).

As used herein, the term “elastomeric polymer” refers to a natural or synthetic polymer, rubber, or rubberoid material, which has the ability to undergo deformation under the influence of a force and regain its original shape once the force has been removed.

As used herein the term “cellulosic fiber” refers to particulates, fibrous cellulose, fibers, and bundles of fibers produced by plants that are generally based on arrangements of cellulose.

As used herein the term “hardwood fiber” refers to cellulosic fibers derived from broad-leaved trees, non-limiting examples including oak, eucalyptus and birch, having a relatively higher density and hardness compared to softwood trees.

As used herein the term “hardwood pulp” refers to hardwood fiber that has been crushed with grinders, crushed with refiners using steam at high pressures and temperatures, chemically broken up, or a combination of methods to produce a soft shapeless mass.

As used herein the term “softwood fiber” refers to cellulosic fibers derived from cone-bearing seed plants with vascular tissue, non-limiting examples including cedars, cypresses, douglas-firs, firs, junipers, kauris, larches, pines, hemlock, redwoods, spruces, and yews.

As used herein the term “softwood pulp” refers to softwood fiber that has been crushed with grinders, crushed with refiners using steam at high pressures and temperatures, chemically broken up, or a combination of methods to produce a soft shapeless mass.

As used herein the term “wood flour” refers to finely pulverized wood, generally made from sapless softwoods such as pine fir, or in some cases from hardwoods.

As used herein the term “kenaf fibers” refers to cellulosic fibers derived from Kenaf (Hibiscus cannabinus), a species of Hibiscus, native to southern Asia,

As used herein the term “hemp fibers” refers to cellulosic fibers derived from plants belonging to the genus Cannabis.

As used herein the term “jute fibers” refers to the long, soft, shiny vegetable fiber produced from plants in the genus Corchorus, family Malvaceae.

As used herein the term “flax fibers” refers to cellulosic fibers derived from plants, sometimes referred to as linseed, that are a member of the genus Linum in the family Linaceae.

As used herein the term “ramie fibers” refers to cellulosic fibers derived from a flowering plant in the nettle family Urticaceae, native to eastern Asia.

As used herein the term “aspect ratio” refers to the ratio of the length of a fiber particle to the diameter of the fiber particle.

As used herein the terms “foam” or “foamed” refer to a solid that includes the cellulosic fiber filled thermoplastic described herein with voids, pockets, cells, a cellular structure and/or bubbles dispersed within the solid that contain a gas, which can include, as non-limiting examples, air, carbon dioxide, water vapor, and combinations thereof.

As used herein the term “surfboard” refers to an elongate member configured to float, which is suitable for one or more riders to use in a standing position to surf.

As used herein, the term “sailboard” refers to an elongate member configured to float, which is or can be fitted with a sail and is suitable for one or more riders to use in a standing position to windsurf and the like.

As used herein the term “body board” refers to an elongate member configured to float, which is used by a rider to maneuver on ocean waves in a sitting, kneeling, or prone position.

As used herein the term “boogie board” refers to a small roughly rectangular member configured to float, which is used by a rider to maneuver on ocean waves in a prone position.

As used herein the term “sled board” refers to a sliding device that includes an elongate member configured to slide on any sufficiently downward sloping slippery surface, such as snow, ice, grass, metal, or water on a water slide with one or more riders in a sitting, kneeling, or prone position.

As used herein the term “snow board” refers to a sliding device that includes an elongate member configured to slide on a snow-covered downward sloping surface with one or more riders in a standing position.

As used herein the term “skateboard” refers to a narrow elongated wheeled platform adapted for one or more riders to be transported in a standing position.

As used herein the term “snow ski” refers to a narrow generally rectangular sliding device used in pairs to slide on a snow-covered downward sloping surface with a rider in a standing position with one foot secured to each device.

As used herein the term “water ski” refers to a narrow generally rectangular sliding device that can optionally be used in pairs, to glide along the surface of water while being pulled by a motorized water craft with a rider in a standing position with feet secured to one or two of such devices.

As used herein the term “go-kart” refers to a rectangular wheeled platform adapted for one or more riders to be transported in a sitting, kneeling, or prone position.

The articles according to the invention contain a cellulosic fiber filled thermoplastic that includes a copolymer; optionally one or more elastomeric polymers; and one or more cellulosic fibers.

The amount of copolymer in the cellulosic fiber filled thermoplastic will vary depending on its intended use as described herein and the physical properties desired in the article. As such, the cellulosic fiber filled thermoplastic will contain the copolymer at a level of at least about 10%, in some cases at least about 15%, in other cases at least about 20%, in some instances at least about 25%, in other instances at least about 30%, and in some situations at least about 35% by weight of the cellulosic fiber filled thermoplastic. Also, the copolymer can be present at up to about 99.9%, in some embodiments up to about 99%, in other embodiments up to about 98%, in some aspects of the invention up to about 95%, in other aspects up to about 94.9%, in some cases up to about 92.5%, in other cases up to about 90%, in some instances up to about 85%, in other instances up to about 80%, in some situations up to about 75% and in other situations up to about 70% by weight of the cellulosic fiber filled thermoplastic. The amount of copolymer in the cellulosic fiber filled thermoplastic can be any value or range between any of the values recited above.

When included in the present cellulosic fiber filled thermoplastic, the amount of elastomeric polymers in the cellulosic fiber filled thermoplastic will vary depending on its intended use as described herein and the physical properties desired in the article. As such, the amount of elastomeric polymers in the cellulosic fiber filled thermoplastic can be at least about 0.1%, in some cases at least about 0.25%, in other cases at least about 0.5%, in some instances at least about 1%, in other instances at least about 2.5% and in some situations at least about 5% by weight of the cellulosic fiber filled thermoplastic. Also, the amount of elastomeric polymers in the cellulosic fiber filled thermoplastic can be up to about 30%, in some cases up to about 25% and in other cases up to about 20% by weight of the cellulosic fiber filled thermoplastic. The amount of elastomeric polymers in the cellulosic fiber filled thermoplastic can be any value or range between any of the values recited above.

The amount of cellulosic fiber in the cellulosic fiber filled thermoplastic will vary depending on its intended use as described herein and the physical properties desired in the article. As such, the amount of cellulosic fiber in the cellulosic fiber filled thermoplastic can be at least about 0.1%, in some situations at least about 1%, in particular situations at least about 5%, in some cases at least about 10%, in other cases at least about 15% and in some instances at least about 20% by weight of the cellulosic fiber filled thermoplastic. Also, the amount of cellulosic fiber in the cellulosic fiber filled thermoplastic can be up to about 70%, in some situations up to about 65%, in other situations up to about 60%, in some cases up to about 55%, in other cases up to about 50%, in some instances up to about 45%, and in other instances up to about 40% by weight of the cellulosic fiber filled thermoplastic. The amount of cellulosic fiber in the cellulosic fiber filled thermoplastic can be any value or range between any of the values recited above.

The copolymer used in the cellulosic fiber filled thermoplastic provides improved strength and stiffness compared with prior art wood or cellulosic filled molded thermoplastics. Particularly, the copolymer used in the present cellulosic fiber filled thermoplastic is less susceptible to creep and/or warpage when subjected to continuous loads and/or high ambient temperatures.

The copolymer used in the cellulosic fiber filled thermoplastic contains residues formed by polymerizing a mixture that contains one or more primary monomers, one or more maleate-type monomers and optionally one or more other polymerizable monomers.

The primary monomers are selected from styrenic monomers and olefinic monomers and combinations thereof.

The amount of primary monomer residues in the present copolymer depends on the physical properties desired in the article to be made, the amount and type of cellulosic fiber to be used and the type and amount of elastomeric polymer that is used. Typically, the amount of primary monomer residues present in the copolymer is at least about 51%, in some cases at least 55% and in other cases at least 60% based on the weight of the copolymer. Also, the amount of primary monomer residues present in the copolymer can be up to about 99.9%, in some situations up to about 99%, in other situations up to about 95%, in some cases up to about 90%, in other cases up to about 85%, in some instances up to about 80%, and in other instances up to about 75% by weight of the copolymer. The amount and type of primary monomer residues in the copolymer can be any value or range between any of the values recited above.

Any suitable styrenic monomer can be used as one or more of the primary monomers in the invention. Suitable styrenic monomers are those that provide the desirable properties in the present article as described herein. Non-limiting examples of suitable styrenic monomers include, but are not limited to styrene, p-methyl styrene, α-methyl styrene, tertiary butyl styrene, dimethyl styrene, nuclear brominated or chlorinated derivatives thereof and combinations thereof.

Any suitable olefinic monomer can be used as one or more of the primary monomers in the invention. Suitable olefinic monomers are those that provide the desirable properties in the present article as described herein. Non-limiting examples of suitable olefinic monomers include, but are not limited to ethylene; alpha olefins such as propylene, 1-butene, 1-pentene, 1-hexene, 1-heptene, 1-octene, 1-nonene, 1-decene and 1-dodecene; 2-butene; 2-pentene; 2-hexene; 2-octene; and combinations thereof.

The amount of maleate-type monomer residues in the present copolymer depends on the physical properties desired in the article to be made, the amount and type of cellulosic fiber to be used and the type and amount of elastomeric polymer that is used. Typically, the amount of maleate-type monomer residues present in the copolymer is at least about 0.1%, in some instances at least about 1%, in other instances at least about 5%, in some cases at least 10% and in other cases at least 15% based on the weight of the copolymer. Also, the amount of maleate-type monomer residues present in the copolymer can be up to about 49%, in some cases up to about 45%, in other cases up to about 40%, and in some instances up to about 35% by weight of the copolymer. The amount of maleate-type monomer residues in the copolymer can be any value or range between any of the values recited above.

Any suitable maleate-type monomer can be used in the invention. Suitable maleate-type monomers are those that provide the desirable properties in the present article as described herein and include, but are not limited to anhydrides, carboxylic acids and alkyl esters of maleate-type monomers, which include, but are not limited to maleic acid, fumaric acid and itaconic acid. Specific non-limiting examples of suitable maleate-type monomers include maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride. Additionally, acrylic acid and/or methacrylic acid can be used as maleate-type monomers in the present invention.

The amount of and type of other monomer residues in the present copolymer depends on the physical properties desired in the article to be made, the amount and type of cellulosic fiber to be used and the type and amount of elastomeric polymer that is used. When included, the amount of the optional other monomer residues present in the copolymer is at least about 1%, in some cases at least 5% and in other cases at least 10% based on the weight of the copolymer. Also, the amount of other monomer residues present in the copolymer can be up to about 25%, in some cases up to about 20%, and in other cases up to about 15%, by weight of the copolymer. The amount of other monomer residues in the copolymer can be any value or range between any of the values recited above.

Any suitable polymerizable monomer can be included as an “other monomer” as described herein. Suitable other monomers are those that provide the desirable properties in the present article as described herein and include, but are not limited to divinylbenzene, conjugated dienes, alkyl methacrylates, alkyl acrylates, (meth)acrylonitrile, and combinations thereof.

The resulting copolymer formed by polymerizing the above-described monomers can have a weight average molecular weight (Mw, measured using GPC with polystyrene standards) of at least 20,000, in some cases at least 35,000 and in other cases at least 50,000. Also, the Mw of the resulting copolymer can be up to 1,000,000, in some cases up to 750,000, and in other cases up to 500,000. The Mw of the copolymer can be any value or range between any of the values recited above.

Suitable copolymers that can be used in the invention include the styrene/maleic anhydride copolymers available under the trade name DYLARK® from NOVA Chemicals Inc., Pittsburgh, Pa. and the FUSABOND® materials available from E. I. Dupont de Nemours and Company, Wilmington, Del.

The elastomeric polymers can be combined with the copolymer by blending or admixing with the copolymer or by combining the elastomeric polymers with the monomers prior to or during polymerization.

Any suitable elastomeric polymer can be used in the invention. In some embodiments of the invention, combinations of elastomeric polymers are used to achieve desired properties. Suitable elastomeric polymers are those that provide the desirable properties in the present article as described herein and are desirably capable of resuming their shape after being deformed.

In an embodiment of the invention, the elastomeric polymers include, but are not limited to homopolymers of butadiene or isoprene or other conjugated diene, and random, block, AB diblock, or ABA triblock copolymers of a conjugated diene (non-limiting examples being butadiene and/or isoprene) with a styrenic monomer as defined above and/or acrylonitrile. In particular embodiments of the invention the elastomeric polymers include acrylonitrile-butadiene-styrene copolymers (ABS).

In a particular embodiment of the invention, the elastomeric polymers include one or more block copolymers selected from diblock and triblock copolymers of styrene-butadiene, styrene-butadiene-styrene, styrene-isoprene, styrene-isoprene-styrene, partially hydrogenated styrene-isoprene-styrene and combinations thereof.

As used herein, butadiene refers to 1,3-butadiene and when polymerized, to repeat units that take on the 1,4-cis, 1,4-trans and 1,2-vinyl forms of the resulting repeat units along a polymer chain.

In some embodiments of the invention, the elastomeric polymer does not include diene type monomers. In these instances the elastomeric polymers can include copolymers of C₁-C₁₂ linear, branched or cyclic olefins, C₁-C₁₂ linear, branched or cyclic alkyl esters of (meth)acrylic acid, styrenic monomers, and/or (meth)acrylonitrile. Non-limiting examples of this type of elastomeric polymer are the ELVALOY® modifiers for synthetic resins available from E. I. Dupont de Nemours and Company, Wilmington, Del.

In an embodiment of the invention, the elastomeric polymer has a number average molecular weight (Mn) greater than 6,000, in some cases greater than 8,000, and in other cases greater than 10,000 and a weight average molecular weight (Mw) of at least 25,000 in some cases not less than about 50,000, and in other cases not less than about 75,000 and the Mw can be up to 500,000, in some cases up to 400,000 and in other cases up to 300,000. The weight average molecular weight of the elastomeric polymer can be any value or can range between any of the values recited above.

Non-limiting examples of suitable block copolymers that can be used in the invention include the STEREON® block copolymers available from the Firestone Tire and Rubber Company, Akron, Ohio; the ASAPRENE™ block copolymers available from Asahi Kasei Chemicals Corporation, Tokyo, Japan; the KRATON® block copolymers available from Kraton Polymers, Houston, Tex.; and the VECTOR® block copolymers available from Dexco Polymers LP, Houston, Tex.

Any suitable cellulosic fiber can be used in the cellulosic fiber filled thermoplastic of the invention. Suitable cellulosic fibers include those that, together with the copolymer and optional elastomeric polymers provide the desired properties in the article described herein.

The cellulosic fiber filled thermoplastic includes cellulosic materials that are derived from wood as well as those not derived from wood (i.e., other than wood flour, fibers, or pulp, etc.) and can be used, either in addition to or instead of wood-derived materials. Thus, cellulosic fibers can include cellulose in any of a number of forms, including as nonlimiting examples wood flour or fibers, wood pulp, wheat fibers, rice hulls, kenaf, flax, hemp, hardwood fiber, kenaf fibers, wheat fibers, rice hulls, hemp fibers, jute fibers, flax fibers, ramie fibers, softwood fibers, hardwood pulp, softwood pulp, wood flour and combinations thereof. In many cases wood fibers or flour are used, and any commercially available variety is generally suitable for use according to the invention.

The cellulosic fibers can include high aspect ratio materials, low aspect ratio materials, and combinations of each. High aspect ratio fillers offer an advantage, that being a higher strength and modulus for the same level of fiber content in the cellulosic fiber filled thermoplastic. The use of cellulosic fiber materials is advantageous for several reasons. Cellulosic fibers can generally be obtained at relatively low cost. Cellulosic fibers are relatively light in weight, can maintain a high aspect ratio after processing in high intensity thermokinetic mixers, and exhibit low abrasive properties, thus extending machine life.

In embodiments of the invention, the high aspect ratio cellulosic fibers have an aspect ratio of greater than 10, in some cases at least about 15 and in other cases at least about 20 and can have an aspect ratio of up to about 1,000, in some cases up to about 750, in other cases up to about 500 and in other cases up to about 250. In particular embodiments of the invention, the high aspect ratio cellulosic fibers have an aspect ratio of greater than 50, in some cases greater than 100, in other cases greater than 200 and in some instances greater than 500. The aspect ratio of the high aspect ratio cellulosic fibers can be any value or range between any of the values recited above.

In embodiments of the invention, the low aspect ratio cellulosic fibers have an aspect ratio of at least about 1, in some cases at least about 1.25 and in other cases at least about 1.5 and can have an aspect ratio of up to 10, in some cases up to about 7.5, in other cases up to about 5 and in some instances up to about 2.5. The aspect ratio of the low aspect ratio cellulosic fibers can be any value or range between any of the values recited above.

In embodiments of the invention, the cellulosic fibers have a diameter of at least about 1, in some cases at least about 2.5, and in other cases at least about 5 μm and can have a diameter of up to about 500, in some cases up to about 400, in other cases up to about 300, in some instances up to about 250 μm. The diameter of the low aspect ratio cellulosic fibers can be any value or range between any of the values recited above.

In some embodiments of the invention, the wood flour has a particle size of not more than 10, in some cases not more than 20, in other cases not more than 30 and in some instances not more than 40 mesh, in other instances not more than 50 mesh and in some situations not more than 60 mesh.

In embodiments of the invention, the wood flour can have a moisture content of not more than 15%, in some cases not more than 14%, in other cases not more than 13%, and in some instances not more than 12% by weight. In particular aspects of this embodiment, the wood flour can have a moisture content of at least 1%, in some cases at least 2% and in other cases at least 3%. The moisture content of the wood flour can be any value indicated above or range between any of the values indicated above.

In many embodiments of the invention, any variety of hardwood or softwood can be used, usually dependent on the location of the manufacturer.

In some embodiments of the invention, the cellulosic fiber is dried prior to being used to make the present cellulosic fiber filled thermoplastic. In these embodiments, the amount of moisture in the cellulosic fiber material is less than about 3%, in some cases less than about 2%, and in other cases less than about 1% by weight of the cellulosic fiber material.

It should be noted that no bright line exists for determining the line between when a particular cellulosic fiber is no longer considered wood flour and is instead considered wood fiber. As such, according to the present invention, it will often be the case that wood flour will contain some wood fibers and wood fibers will contain some amount of wood flour.

In some embodiments of the invention, the cellulosic fiber can include recycled paper, and in particular embodiments, pelletized recycled paper.

The present cellulosic fiber filled thermoplastic can include one or more additives known in the art. Suitable additives include, but are not limited to heat stabilizers, light stabilizers, antioxidants; plasticizers, dyes, pigments; anti-blocking agents; slip agents; lubricants; coloring agents; ultraviolet light absorbers; fillers; anti-static agents; impact modifiers, and combinations thereof. Unless otherwise indicated, each of the additives can be included in amounts of less than about 5, in some cases less than about 4, in other cases less than about 3, and in some instances less than about 2 weight % based on the cellulosic fiber filled thermoplastic. Typically, the total amount of additives in the cellulosic fiber filled thermoplastic will be less than about 12, in some cases less than about 10 and in other cases less than about 8 weight % based on the cellulosic fiber filled thermoplastic.

In an embodiment of the invention, the cellulosic fiber filled thermoplastic can be compounded or otherwise blended with one or more other polymers to form a cellulosic fiber filled thermoplastic blend. Suitable other polymers that can be blended or compounded with the cellulosic fiber filled thermoplastic composition include, but are not limited to crystal polystyrene, high impact polystyrenes, polyphenylene oxide, copolymers of styrene and maleic anhydride and/or C₁-C₁₂ linear, branched or cyclic alkyl (meth)acrylates, rubber-modified copolymers of styrene and maleic anhydride and/or C₁-C₁₂ linear, branched or cyclic alkyl (meth)acrylates, polycarbonates, polyamides (such as the nylons), polyesters (such as polyethylene terephthalate, PET), polyolefins (such as polyethylene, polypropylene, and ethylene-propylene copolymers), polyphelyne ether (PPE), polyvinylidene fluoride, acrylonitrile/(meth)acrylate copolymers, ethylene/vinyl acetate copolymers, polyoxymethylene, acetal copolymer, ethylene vinyl alcohol copolymers, and combinations thereof.

In particular embodiments of the invention, the compounded blend includes polyoxymethylene (POM or Acetal), which, as a non-limiting example is available under the trade name DELRIN® from E.I. DuPont De Nemours and Company, Wilmington, Del.

When a cellulosic fiber filled thermoplastic blend is used, the blend will typically include at least 1%, in some instances at least 5%, and in other instances at least 10%, in some cases at least 25%, and in other cases at least 35% and up to 99%, in some instances up to 95%, in other instances up to 90%, in some cases up to 75%, and in other cases up to 65% by weight based on the blend of the present cellulosic fiber filled thermoplastic. Also, the blend will typically include at least 1%, in some instances at least 5%, and in other instances at least 10%, in some cases at least 25%, and in other cases at least 35% and up to 99%, in some instances up to 95%, in other instances up to 90%, in some cases up to 75%, and in other cases up to 65% by weight based on the blend of the other polymers. The amount of the present cellulosic fiber filled thermoplastic and other polymers in the blend is determined based on the desired properties in the articles to be made using the blend composition. The amount of the present cellulosic fiber filled thermoplastic and other polymers in the blend can be any value or range between any of the values recited above.

Suitable heat stabilizers that can be used in the invention include, but are not limited to, phosphite or phosphonite stabilizers and hindered phenols, non-limiting examples being the IRGANOX® stabilizers and antioxidants available from Ciba Specialty Chemicals.

Generally, any conventional ultra-violet light (UV) stabilizer known in the art can be utilized in the present invention. Non-limiting examples of suitable UV stabilizers include 2-hydroxy-4-(octyloxy)-benzophenone, 2-hydroxy-4-(octyl oxy)-phenyl phenyl-methanone, 2-(2′-hydroxy-3,5′di-teramylphenyl)benzotriazole, and the family of UV stabilizers available under the trade TINUVIN® from Ciba Specialty Chemicals Co., Tarrytown, N.Y.

Suitable plasticizers that can be used in the invention include, but are not limited to cumarone-indene resin, a terpene resin, and oils.

As used herein, “pigments and/or dyes” refer to any suitable inorganic or organic pigment or organic dyestuff. Suitable pigments and/or dyes are those that do not adversely impact the desirable physical properties of the article. Non-limiting examples of inorganic pigments include titanium dioxide, iron oxide, zinc chromate, cadmium sulfides, chromium oxides and sodium aluminum silicate complexes. Non-limiting examples of organic type pigments include azo and diazo pigments, carbon black, phthalocyanines, quinacridone pigments, perylene pigments, isoindolinone, anthraquinones, thioindigo and solvent dyes. The pigments can be white or any other color. The white pigment can be produced by the presence of titanium oxide, zinc oxide, magnesium oxide, cadmium oxide, zinc chloride, calcium carbonate, magnesium carbonate, etc., or any combination thereof in the amount of 0.1 to 20% by weight, depending on the white pigment to be used. The colored pigment can be produced by carbon black, phtalocyanine blue, Congo red, titanium yellow or any other coloring agent known, as for example, in the printing industry.

Suitable anti-blocking agents, slip agents or lubricants include, but are not limited to silicone oils, liquid paraffin, synthetic paraffin, mineral oils, petrolatum, petroleum wax, polyethylene wax, hydrogenated polybutene, higher fatty acids and the metal salts thereof, linear fatty alcohols, glycerine, sorbitol, propylene glycol, fatty acid esters of monohydroxy or polyhydroxy alcohols, phthalates, hydrogenated castor oil, beeswax, acetylated monoglyceride, hydrogenated sperm oil, ethylenebis fatty acid esters, and higher fatty amides. Suitable lubricants include, but are not limited to, ester waxes such as the glycerol types, the polymeric complex esters, the oxidized polyethylene type ester waxes and the like, metallic stearates such as barium, calcium, magnesium, zinc and aluminum stearate, salts of 12-hydroxystearic acid, amides of 12-hydroxystearic acid, stearic acid esters of polyethylene glycols, castor oil, ethylene-bis-stearamide, ethylene bis cocamide, ethylene bis lauramide, pentaerythritol adipate stearate and combinations thereof.

Suitable ultraviolet light absorbers that can be used in the invention include, but are not limited to 2-(2-hydroxyphenyl)-2H-benzotriazoles, for example, known commercial hydroxyphenyl-2H-benzotriazoles and benzotriazoles hydroxybenzophenones, acrylates, malonates, sterically hindered amine stabilizers, sterically hindered amines substituted on the N-atom by a hydroxy-substituted alkoxy group, oxamides, tris-aryl-o-hydroxyphenyl-s-triazines, esters of substituted and unsubstituted benzoic acids, nickel compounds, and combinations thereof.

Suitable fillers are those that do not adversely impact, and in some cases enhance, the desirable physical properties of the article. Suitable fillers include, but are not limited to, calcium carbonate in ground and precipitated form, barium sulfate, talc, glass, clays such as kaolin and montmorolites, mica, silica, alumina, metallic powder, glass spheres, barium stearate, calcium stearate, aluminum oxide, aluminum hydroxide, titanium dioxide, diatomaceous earth, fiberglass and combinations thereof. The amount of filler is desirably less than 10% of the total weight of the cellulosic fiber filled thermoplastic.

Examples of suitable anti-static agents include, but are not limited to glycerine fatty acid, esters, sorbitan fatty acid esters, propylene glycol fatty acid esters, stearyl citrate, pentaerythritol fatty acid esters, polyglycerine fatty acid esters, and polyoxethylene glycerine fatty acid esters.

Examples of suitable impact modifiers include, but are not limited to high impact polystyrene (HIPS), styrene/butadiene block copolymers, ABS, copolymers of C₁-C₁₂ linear, branched or cyclic olefins, C₁-C₁₂ linear, branched or cyclic alkyl esters of (meth)acrylic acid, styrenic monomers, styrene/ethylene/-butene/styrene, block copolymers, styrene/ethylene copolymers. The amount of impact modifier used is typically in the range of 0.5 to 25% of the total weight of cellulosic fiber filled thermoplastic.

The cellulosic fiber filled thermoplastic can be extruded by melt mixing at a temperature sufficient to flow the copolymer and extruding through an extruder die any of the cellulosic fiber filled thermoplastic disclosed herein one or more times. Both single-pass or multiple-pass extrusion can be used in the invention.

After being formed, the article has a thickness of at least about 0.1, in some instances at least about 0.15, in other instances at least about 0.25, in some cases at least about 0.5 and in other cases at least about 1 cm and can have a thickness of up to about 35, in some instances up to about 30 cm, in other instances up to about 25 cm, in some situations up to about 20 cm, in other situations up to about 15, in some cases up to about 12 cm, and in other cases up to about 10 cm. The thickness of the article can be any value or range between any of the values recited above.

A particular advantage of the present cellulosic fiber filled thermoplastic over prior art wood fiber and/or wood four filled polyolefins is the superior tensile properties of the present cellulosic fiber filled thermoplastic.

In embodiments of the invention, the tensile modulus of the present cellulosic fiber filled thermoplastic, determined according to ISO 527-2, is greater than 2,000, in some cases greater than 2,500 and in other cases greater than 3,000 MPa, depending on the particular thermoplastic and cellulosic fiber that is used.

In additional embodiments of the invention, the tensile strength, determined according to ISO 527-2, of the cellulosic fiber filled thermoplastic can be at least about 25, in some cases at least about 30, in other cases at least about 35 and in some instances at least about 40 MPa depending on the particular thermoplastic and cellulosic fiber that is used.

In particular embodiments of the invention, the cellulosic fiber filled thermoplastic of the invention has a tensile modulus, determined according to ISO 527-2, that is at least 1.5, in some cases at least 1.75 and in other cases at least 2 times greater than the tensile modulus of a similarly composed material containing cellulosic fiber and polypropylene. Further to this embodiment, the cellulosic fiber filled thermoplastic of the invention has a tensile strength, determined according to ISO 527-2, that is at least 1.5, in some cases at least 1.75 and in other cases at least 2 times greater than the tensile strength of a similarly composed material containing cellulosic fiber and polypropylene.

In other embodiments of the invention, the deflection temperature under load (DTUL) at 1.82 MPa determined according to ISO-75-2, of the cellulosic fiber filled thermoplastic is at least about 85° C.

In embodiments of the invention, the flexural properties of the present cellulosic fiber filled thermoplastic material can be characterized by the modulus of rupture of the material. According to this embodiment, the modulus of rupture determined according to ASTM D 790, is greater than 750, in some cases greater than 900 and in other cases at least 1,000 psi, depending on the particular thermoplastic and cellulosic fiber that is used.

In embodiments of the invention, the flexural properties of the present cellulosic fiber filled thermoplastic material can be characterized by the modulus of elasticity of the material. According to this embodiment, the modulus of elasticity determined according to ASTM D 790, is greater than 75,000; in some cases greater than 90,000 and in other cases at least 100,000 psi, depending on the particular thermoplastic and cellulosic fiber that is used.

In embodiments of the invention, the flexural properties of the present cellulosic fiber filled thermoplastic material can be characterized by the modulus of rupture of the material. According to this embodiment, the modulus of rupture determined according to ASTM D 790, is greater than 750, in some cases greater than 900 and in other cases at least 1,000 psi, and in some cases can be up to 20,000 psi depending on the particular thermoplastic and cellulosic fiber that is used.

In embodiments of the invention, the flexural properties of the present cellulosic fiber filled thermoplastic material can be characterized by the modulus of elasticity of the material. According to this embodiment, the modulus of elasticity determined according to ASTM D 790, is greater than 75,000; in some cases greater than 90,000 and in other cases at least 100,000 psi and in some cases can be up to 1,000,000 psi depending on the particular thermoplastic and cellulosic fiber that is used.

In embodiments of the invention, the tensile properties of the present cellulosic fiber filled thermoplastic material can be characterized by the modulus of rupture of the material. According to this embodiment, the modulus of rupture determined according to ASTM D 638, is greater than 500, in some cases greater than 650 and in other cases at least 750 psi, and in some cases can be up to 20,000 psi depending on the particular thermoplastic and cellulosic fiber that is used.

In embodiments of the invention, the tensile properties of the present cellulosic fiber filled thermoplastic material can be characterized by the modulus of elasticity of the material. According to this embodiment, the modulus of elasticity determined according to ASTM D 638, is greater than 100,000; in some cases greater than 125,000 and in other cases at least 150,000 psi and in some cases can be up to 1,500,000 psi depending on the particular thermoplastic and cellulosic fiber that is used.

In embodiments of the invention, the impact properties of the present cellulosic fiber filled thermoplastic material can be characterized by the Izod impact resistance of the material. According to this embodiment, the Izod impact resistance is determined according to ASTM D 256, is less than 80, in some instances less than 60, in other instances less than 50, in some situations less than 40, in other situations less than 30, in some cases less than 25 and in other cases not more than 22 J/M and in some cases can be as low as 1 J/M depending on the particular thermoplastic and cellulosic fiber that is used.

Not wishing to be limited to any single theory, it is believed that one reason for the superior tensile properties and other superior physical properties of the present cellulosic fiber filled thermoplastic over prior art materials is that the acid and/or anhydride groups in the copolymer are able to react and bind to hydroxyl groups in the cellulosic fiber resulting in a stronger compounded matrix of thermoplastic and filler.

In many embodiments of the invention, the reaction of the acid and/or anhydride groups in the copolymer with the hydroxyl groups in the cellulosic fiber result in a byproduct that can include water and carbon dioxide and depending on the materials used low molecular weight organic compounds containing hydroxyl, carbonyl and carboxylic acid functionality. Under extrusion conditions, the water and carbon dioxide and when present organic compounds act as a blowing agent and cause a cellular structure or foam to form in at least a portion of the cross-section of the extruded article. The foam or cellular structure causes the density of the extruded article to be lower, often less dense than water and provides many of the unique properties of the present cellulosic fiber filled thermoplastic articles.

In embodiments of the invention, the extrusion conditions can cause the evolving water and carbon dioxide to remove or extract organic materials from the cellulosic fibers. Depending on the type of fiber used, the particular species can vary and can include as non-limiting examples pentanal, pentanol, hexanal, furadehyde, heptanone, heptanal, pinene, camphene, benzaldehyde, octanal, p-cymene, limonene, nonanone, nonanal, campholene aldehyde, camphor, 1-methoxy-4-(2-propenyl)-benzene, verbenone, 4-isopropyl benzaldehyde, borneol, undecenal, eicosane, heneicosane, docosane, tetracosane, formaldehyde, methanol, and combinations thereof. When present with the evolving water and carbon dioxide mixture, the organic materials can also act as blowing agents in the formation of the present articles.

In particular embodiments of the invention, a center portion of a cross-section of the present cellulosic fiber filled thermoplastic article is foamed and the portion around the edge or perimeter of the present cellulosic fiber filled thermoplastic article is minimally foamed or not foamed at all.

In some embodiments of the invention, the center portion can be highly foamed to the extent that the cellulosic fiber filled thermoplastic article is nearly or completely hollow.

The density of the foamed cellulosic fiber filled thermoplastic articles, as a whole, of this embodiment are often less than 1 g/cm³, and can be less than 0.97 g/cm³, in some cases less than 0.9 g/cm³, in other cases less than 0.85 g/cm³, and in some instances less than 0.8 g/cm³. The density of the foamed cellulosic fiber filled thermoplastic articles will depend on the composition of the copolymer, amount and type of cellulosic material, the amount of moisture present, as well as the particular processing conditions.

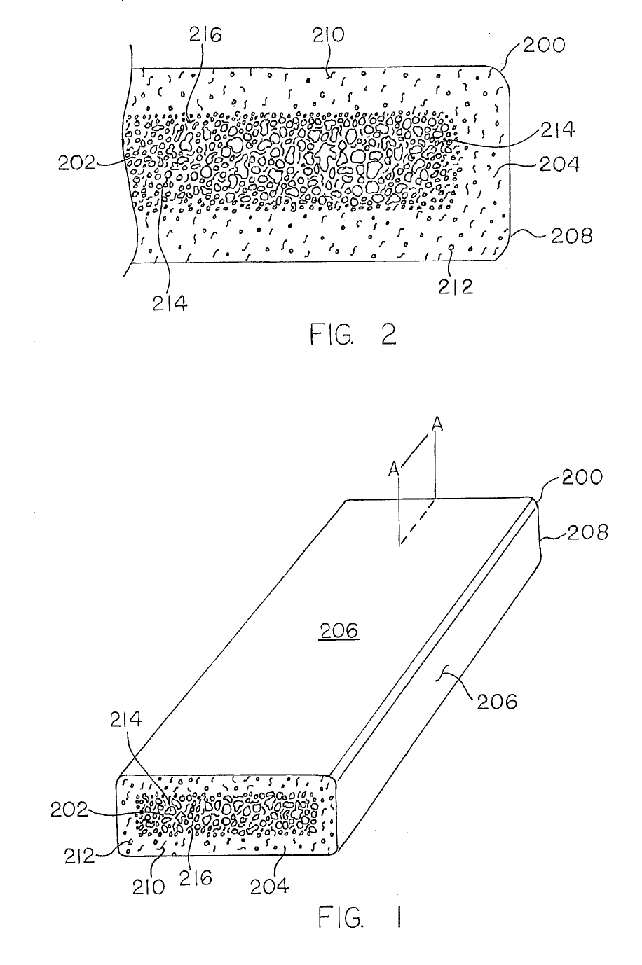

In embodiments of the invention, as shown for example in FIGS. 1 and 2, extruded article 200 has structured foam central portion 202 and micro foamed outer portion 204. In this embodiment, central portion 202 does not touch outer surface 206 of article 200, but extends for all or part of the length of article 200. In some aspects of this embodiment, the extrusion process is modified to close of one or both ends 208 of article 200 so that outer portion 204 encompasses end 208.

As used herein, the term “micro foamed” refers to a material where the cellulosic fibers 210 are well, and in many cases homogenously, dispersed with the copolymer and small voids 212, typically less than 50 μm, are dispersed throughout the material.

As used herein, the term “structured foam” refers to a material where the cellulosic fibers 212 are well, and in many cases homogenously, dispersed with the copolymer and large voids 214, typically greater than 50 μm, are located throughout the material, separated by walls 216, that can be from 50 μm to 10 mm thick. In some cases the size distribution of the large voids can be large.

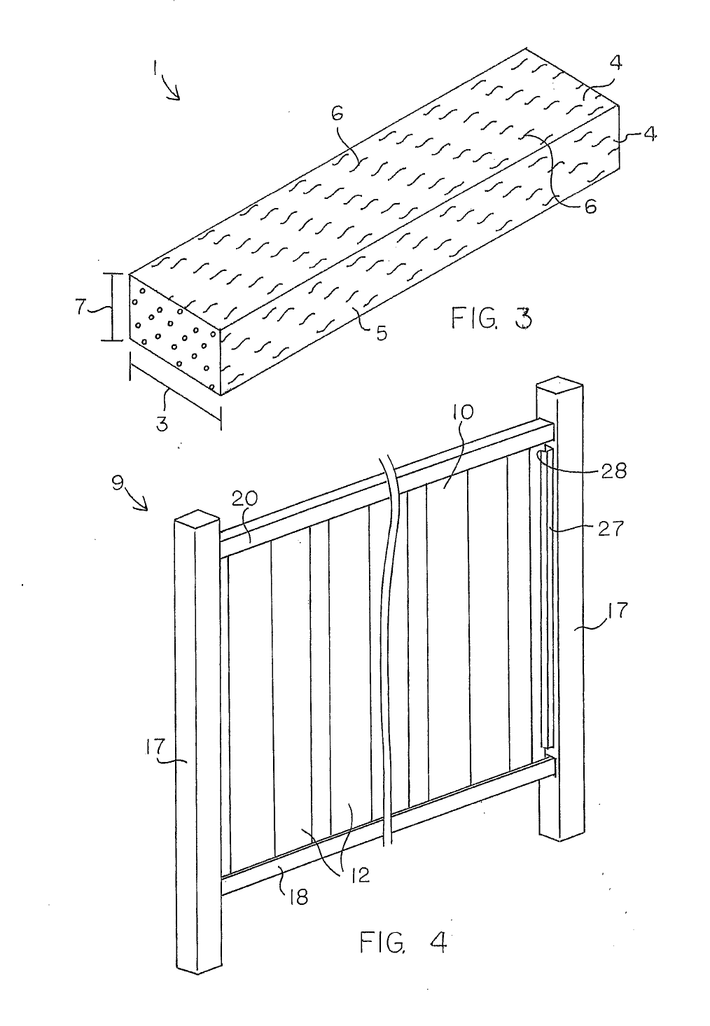

In embodiments of the invention shown in FIG. 3, extruded article 1 can be uniformly micro foamed. As such, cellulosic fibers 6 are well, and in many cases homogenously, dispersed with the copolymer and small voids 8, typically less than 50 μm, are dispersed throughout the material.

The small voids in the micro foamed material can have a diameter of at least 0.01, in some cases at least 0.1 and in other cases at least 1 μm and can be less than 50, in some cases up to 49, in other cases up to 45, in some instances up to 40, in other instances up to 35, in some situations up to 30 and in other situations up to 25 μm. The size of the small voids in the micro foamed material will vary based on the composition of the copolymer, the type of cellulose and the particular extrusion conditions employed. The size of the small voids in the micro foamed material can be any value or range between any of the values recited above.

In embodiments of the invention, the density of the micro foamed material can be at least 0.6, in some cases at least 0.64 and in other cases at least 0.68 g/cm³ and can be up to 1.1, in some cases up to 1.06 and in other cases up to 1.02 g/cm³. The density of the micro foamed material will vary based on the composition of the copolymer, the type of cellulose and the particular extrusion conditions employed. The density of the micro foamed material can be any value or range between any of the values recited above.

The large voids in the structured foamed material can have a diameter of at least 50, in some cases at least 55 and in other cases at least 60 μm and can be up to 2,500, in some cases up to 2,000, in other cases up to 1,500, in some instances up to 1,000, in other instances up to 500, in some situations up to 400 and in other situations up to 250 μm. The size of the large voids in the structured foamed material will vary based on the composition of the copolymer, the type of cellulose and the particular extrusion conditions employed. The size of the large voids in the structured foamed material can be any value or range between any of the values recited above.

In embodiments of the invention, the density of the structured foamed material is less than the density of the micro foamed material. In aspects of this embodiment, the structured foamed material can be at least 0.45, in some cases at least 0.50 and in other cases at least 0.55 g/cm³ and can be up to 0.80, in some cases up to 0.75 and in other cases up to 0.7 g/cm³. The density of the structured foamed material will vary based on the composition of the copolymer, the type of cellulose and the particular extrusion conditions employed. The density of the structured foamed material can be any value or range between any of the values recited above.

In embodiments of the invention, the flexural properties of the micro foamed portion of the present cellulosic fiber filled thermoplastic material are greater than that of the structured foam portion as characterized by the modulus of rupture of the material determined according to ASTM D 790. In this embodiment of the invention, the structured foam portion can have a modulus of rupture that is greater than 750, in some cases greater than 900 and in other cases at least 1,000 psi and can be up to 10,000 psi, depending on the particular thermoplastic and cellulosic fiber that is used. In this embodiment, the micro foam portion can have a modulus of rupture that is greater than 1,000, in some cases greater than 1,150 and in other cases at least 1,300 psi and can be up to 20,000 psi, depending on the particular thermoplastic and cellulosic fiber that is used.

In embodiments of the invention, the flexural properties of the micro foamed portion of the present cellulosic fiber filled thermoplastic material are greater than that of the structured foam portion as characterized by the modulus of elasticity of the material determined according to ASTM D 790. In this embodiment of the invention, the structured foam portion can have a modulus of rupture that is greater than 75,000; in some cases greater than 90,000 and in other cases at least 100,000 psi and can be up to 700,000 psi depending on the particular thermoplastic and cellulosic fiber that is used. In this embodiment, the micro foam portion can have a modulus of elasticity that is greater than 100,000, in some cases greater than 125,000 and in other cases at least 150,000 psi and can be up to 750,000 psi, depending on the particular thermoplastic and cellulosic fiber that is used.

In embodiments of the invention, the tensile properties of the micro foamed portion of the present cellulosic fiber filled thermoplastic material are greater than that of the structured foam portion as characterized by the modulus of rupture of the material. In this embodiment of the invention, the structured foam portion can have a modulus of rupture determined according to ASTM D 638, that is greater than 500, in some cases greater than 650 and in other cases at least 750 psi, and in some cases can be up to 10,000 psi depending on the particular thermoplastic and cellulosic fiber that is used. In this embodiment, the micro foam portion can have a modulus of rupture that is greater than 1,000, in some cases greater than 1,250 and in other cases at least 1,500 psi and can be up to 20,000 psi, depending on the particular thermoplastic and cellulosic fiber that is used.

In embodiments of the invention, the tensile properties of the micro foamed portion of the present cellulosic fiber filled thermoplastic material are greater than that of the structured foam portion as characterized by the modulus of elasticity of the material. In this embodiment of the invention, the structured foam portion can have a modulus of elasticity determined according to ASTM D 638 that is greater than 100,000; in some cases greater than 125,000 and in other cases at least 150,000 psi and in some cases can be up to 1,500,000 psi depending on the particular thermoplastic and cellulosic fiber that is used. In this embodiment, the micro foam portion can have a modulus of elasticity that is greater than 200,000, in some cases greater than 225,000 and in other cases at least 250,000 psi and can be up to 2,000,000 psi, depending on the particular thermoplastic and cellulosic fiber that is used.

In embodiments of the invention, the Izod impact properties of the micro foamed portion of the present cellulosic fiber filled thermoplastic material are higher than that of the structured foam portion as characterized by the Izod impact resistance of the material. In this embodiment of the invention, the structured foam portion has a lower Izod impact resistance determined according to ASTM D 256 that is less than 30, in some cases less than 25 and in other cases not more than 22 J/M and in some cases can be as low as 1 J/M depending on the particular thermoplastic and cellulosic fiber that is used. In this embodiment of the invention, the micro foam portion can have an Izod impact resistance determined according to ASTM D 256 that is less than 50, in some cases less than 40 and in other cases not more than 35 J/M and in some cases can be as low as 1 J/M depending on the particular thermoplastic and cellulosic fiber that is used.

Embodiments of the present invention also provide a method of making the articles described herein. The method includes a) combining the copolymer and optional elastomeric polymers to form a compounded copolymer; b) combining the cellulosic fibers with the compounded copolymer to form a cellulosic compounded copolymer; and c) extruding the cellulosic compounded copolymer to form an extruded article.

In embodiments of the invention, the copolymer and elastomeric copolymer are combined by melt blending.

In embodiments of the invention, the copolymer and/or compounded copolymer and cellulosic fibers are combined by melt blending.

In embodiments of the invention, the compounding steps will generally include an extruder. The extruder may be a single or twin-screw extruder. In many cases, the extruder is one that can carry out the compounding process under vacuum.

In some embodiments of the invention, the cellulosic fiber filled thermoplastic can be formed using a kinetic mixer, a Banbury mixer, a Brabender mixer and/or a twin-screw extruder. The cellulosic fiber filled thermoplastic can be blended and kneaded using methods known in the art at any suitable stage in the process until the point just before production of the final product. Blending can be effected by various methods, such as using a suitable mixer such as tumbler, Henschel mixer, etc., or supplying the measured amounts of the component materials to the extruder hopper by a feeder and mixing them in the extruder. Kneading may also be accomplished by suitable known methods such as using a single- or double-screw extruder.

In embodiments of the invention, profile extrusion techniques are used to form the article. In this embodiment, the cellulosic fiber filled thermoplastic is fed to an extruder, where the material is conveyed continuously forward by a rotating screw inside a heated barrel and is softened by both friction and heat. The softened cellulosic fiber filled thermoplastic is then forced through a die and directly into cool water where the cellulosic fiber filled thermoplastic solidifies to form the article.

In embodiments of the invention, a first-pass method can be used whereby the components (cellulosic fibers, copolymer, elastomeric polymers, and any additives) are gravity fed into a volume extruder and pellets of a homogeneous composition are thus formed.

In some embodiments, it is necessary to include a second pass that begins with already homogeneous pellets of relatively uniform size. Property and output rate fluctuations due to imperfect mixing are largely eliminated when the pellets are melted and re-extruded in a second pass.

The cellulosic fiber filled thermoplastic of the invention may also be used in other forming processes, i.e. injection molding, compression molding, co extrusion, and blow molding or via extrusion methods for film or sheet, and thermoforming for producing parts such as those listed in the preceding paragraph.

An embodiment of the invention is shown in FIG. 3, where the article is synthetic board 1, which can include a blend of the copolymer and elastomeric polymer, a plurality of cellulosic fibers 6 compounded with blend 2 to form a cellulosic fiber filled thermoplastic 4. Board 1 has a width 3, a thickness 7, and a side 5. Board 1 can be used as a decking component or any other suitable building material. For example, as shown in FIG. 3, board 1 can be used as a decking board, railing, railing post, and/or decking beam. In another example, board 1 can be used to construct any portion of homes, walkways, shelters, and/or any other desirable structure.

Width 3 of board 1 can be at least about 1 cm, in some cases at least about 2 cm and in other cases at least about 4 cm and can be up to about 250 cm, in some cases up to about 244 cm, in other cases up to about 215 cm, in some instances up to about 185 cm and in other instances up to about 125 cm. Width 3 can be any value or range between any of the values recited above.

Thickness 7 of board 1 can be at least 1 cm, in some cases at least about 2 cm and in other cases at least about 4 cm and can be up to about 12, in some cases up to about 11, and in other cases up to about 10 cm. Thickness 7 of board 1 can be any value or range between any of the values recited above.

Side 5 of board 1 can be extruded to any desired length. In embodiments of the invention, board 1 is extruded to a commercially useful length of side 5 of board 1, which can be at least about 5, in some cases at least about 10, in other cases at least about 20, and in some instances at least about 25 cm long and can be up to about 1,000, in some cases up to about 625, in other cases up to about 475, and in other instances up to about 375 cm. The length of side 5 of board 1 can be any value or range between any of the values recited above.

An embodiment of the invention is shown in FIG. 4, where a plurality of boards according to the invention are used to construct fence 9. In fence 9, fence plate 10 is surrounded by a fence frame formed of a plurality of boards which provide strength to fence 9. The boards can be solid or hollow, and can be square, or formed in any other suitable polygonal cross-sectional shape.

Fence 9 can be formed using two connector beams 17, a base beam 18 and a top beam 20 all made of the cellulosic fiber filled thermoplastic according to the invention. In embodiments of the invention, base beam 18 can include a longitudinal groove; into which is seated a bottom side of fence plate 10 and top beam 20 includes a longitudinal groove mounted onto the top side of fence plate 10. Each of the connector beams 17 can include one or more bores, which engage one or more of beams 18 and 20. In many cases, each connector beam 17 includes two bores, intermediate which is formed an elongate panel mount 27 including a notch 28, which engages one vertical side of fence plate 10.

Fence plate 10 can have a length in the range of from 3 to 6 feet and a height in the range of 1 to 20 feet and the ratio between the height and width of each fence plate 10 can be less than 2:1.

One or more of fence plate 10, connector beams 17, base beam 18 and top beam 20 can be made from the cellulosic fiber filled thermoplastic boards of the present invention.

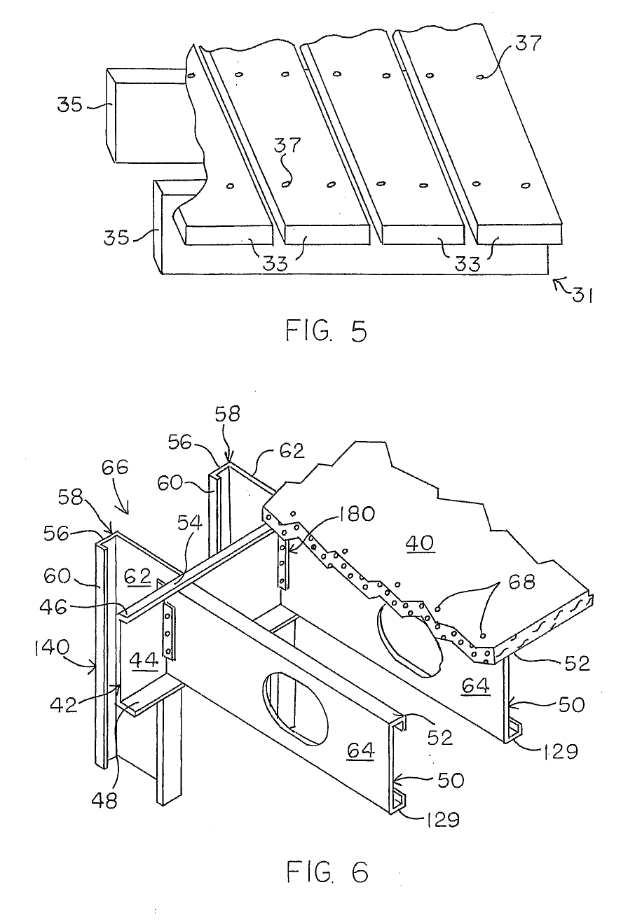

Referring now to FIG. 5, deck system 31 includes a plurality of individual deck boards 33 which are disposed transversely across a plurality of widely spaced joists 35, adjacent deck boards 33 being spaced apart a distance D which typically falls within the range of approximately ⅛ of an inch to approximately ½ of an inch (the particular spacing between adjacent deck boards 33 often being selected based on the environmental conditions to which deck 31 will be subjected). With deck boards 33 disposed across joists 35, a plurality of conventional nails 37 are driven down through each deck board 33 and into a corresponding joist 35. One or both of deck boards 33 and joists 35 can be made from the cellulosic fiber filled thermoplastic boards of the present invention.

In embodiments of the invention, the cellulosic fiber filled thermoplastic boards can have panel-type dimensions, as a non limiting example, about 2 to about 8 feet wide, about 6 to about 12 feet long and about 0.5 to about 4 inches thick. In this embodiment, the cellulosic fiber filled thermoplastic panel can be attached to studs or joists to form a surface for a wall, a floor or a roof. As shown in FIG. 6, described in connection with the use of floor panel 40, C-shaped joist rim 42 has a web 44 and an upper flange 46 and a lower flange 48. Joists 50 are attached by way of upper joist flanges 52 of the joists 124 can be affixed to the upper rim flange 46 of joist rim 42 by appropriate fasteners 54 such as, for example, #10-16 screws or the like.

The joist rim 42 can be attached to the stud flanges 56 of the studs 58 such that the upper rim flange 46 of the joist rim 44 is substantially co-planar with the ends 60 of the studs 62 and the upper flanges of the joists 64 to form a substantially coplanar frame arrangement, generally designated as 66, for receiving cellulosic fiber filled thermoplastic panel 40. The cellulosic fiber filled thermoplastic panel 40 can be attached to the joists by an appropriate number and appropriate orientation of fasteners 68 such as, for example, #10-16 screws or the like.

In embodiments of the invention, the article can be a sports board. As those skilled in the art can appreciate, the cellulosic fiber filled thermoplastic according to the invention can be used to replace all or part of the sports board components that are often made from wood. As non-limiting examples, the sports board that can contain the present cellulosic fiber filled thermoplastic include surfboards, body boards, sailboards, boogie boards, tow boards, water skis, snow boards, sleds, toboggans, snow skis, go-karts, and skate boards.

In embodiments of the invention, the cellulosic fiber filled thermoplastic materials described herein can be used in a thermoplastic molding process and apparatus as described in U.S. Pat. Nos. 7,208,219; 6,900,547; 6,869,558; and 6,719,551 and U.S. Patent Application Publication Nos. 2006/0008967 and 2004/0253430 as well as to make the products described in those references. The cellulosic fiber filled thermoplastic materials can be used to make molded panels and molded panel systems as disclosed in U.S. Patent Application Publication No. 2007/0164481. The relevant disclosures of the references cited in this embodiment are herein incorporated by reference.

The present invention will further be described by reference to the following examples. The following examples are merely illustrative of the invention and are not intended to be limiting. Unless otherwise indicated, all percentages are by weight unless otherwise specified.

### EXAMPLES

The following equipment was used in processing the examples described below.
Extrusion processing was carried out using a WT-94 WOODTRUDER® extruder using a 94 mm counter-rotating parallel twin-screw extruder (28:1 L/D) with a coupled Mark V® 75 mm single-screw extruder available from Davis-Standard Corporation, Pawcatuck, Conn.
Gravimetric feeders (Colortronic North America, Inc., Flint, Mich.) were used to supply the extruders.
Styrene-Maleic Anhydride (SMA) resins used were DYLARK® 332 resin and DYLARK® 378 resin (available from NOVA Chemicals Inc., Pittsburgh, Pa.
Cellulosic fiber used was 40 mesh pine sawdust available from American Wood Fibers, Inc., Schofield, Wis.
Lubricant used was EPOLENE® wax available from Eastman Chemical Company, Kingsport, Tenn.

### Example 1

Styrene-maleic copolymers (SMA), wood fiber and lubricant (STRUKTOL® 113, Schill & Seilacher GmbH & Co., Hamburg, Germany) were combined in a RHEOMIXER™ (C. W. Brabender Instruments, Inc., South Hackensack, N.J.) equipped with a condensing system and vacuum as indicated in the table below (all weight percentages). A total of 200 g of material were mixed at 240° C. for three minutes at 55 rpm. The mixture reacted and generated a blowing agent that was captured for analysis in the condensing system.

| | | | | Moisture | |
|---|---|---|---|---|---|
| | | | | Content | |
| Sample | SMA Type | SMA | fiber | in fibers | Lubricant |
| A | DYLARK ® 232 | 70 | 25 | 8 | 5 |
| | resin | | | | |
| B | DYLARK ® 332 | 70 | 25 | 0 | 5 |
| | resin | | | | |
| C | DYLARK ® 332 | 55 | 40 | 8 | 5 |
| | resin | | | | |
| D | DYLARK ® 232 | 55 | 40 | 0 | 5 |
| | resin | | | | |
| E | DYLARK ® 338 | 65 | 30 | 4 | 5 |
| | resin | | | | |

The recovered liquid was diluted in methylene chloride and analyzed using FTIR spectroscopy. The analysis was consistent from sample to sample, regardless of fiber moisture content. The recovered liquid was an aqueous mixture containing carbon dioxide and carbonic acid (indicating evolution of carbon dioxide) as well as organic compounds containing hydroxyl, carbonyl and carboxylic acid functionality.

The amount of recovered liquid did not vary significantly with the moisture content of the fibers suggesting that the liquid was primarily the reaction product of the hydroxyl groups of the fibers and the maleic anhydride groups of the SMA.

### Example 2

Wood filled SMA samples were prepared using the combinations of ingredients in the following table. All values are weight percentages.

| Sample | SMA Resin | | Cellulosic | |
|---|---|---|---|---|
| No. | type | SMA | fiber | Lubricant |
| 1 | 332 | 70 | 25 | 5 |
| 2 | 332 | 69 | 25 | 6 |
| 3 | 378 | 78 | 18 | 4 |
| 4 | 378 | 70 | 25 | 5 |
| 5 | 378 | 64 | 30 | 6 |

The following extrusion parameters were used to prepare each of Samples 1-5.

| | Mark V ® | WOODTRUDER ® |
|---|---|---|
| Parameter | extruder | extruder |
| Barrel Zone 1 (° C.) | 250 | 30 |
| Barrel Zone 2 (° C.) | 240 | 230 |
| Barrel Zone 3 (° C.) | 220 | 225 |
| Barrel Zone 4 (° C.) | 210 | 220 |
| Barrel Zone 5 (° C.) | 205 | 210 |
| Barrel Zone 6 (° C.) | — | 205 |
| Barrel Zone 7 (° C.) | — | 205 |
| Barrel Zone 8 (° C.) | — | 200 |
| Melt (° C.) | 205 | — |
| Adapter (° C.) | 220 | 220 |
| Clamp (° C.) | 220 | 220 |
| Pressure (psi) | 1600-1700 | 25-100 |
| Load (%) | 46 | 19 |
| Screw Speed (rpm) | 37 | 24 |

During the extrusion process, a blowing agent was generated, consistent with the aqueous liquid described in Example 1 resulting from reaction of the anhydride groups of the SMA and the hydroxyl groups of the cellulosic fiber. The blowing agent caused a foam structure to form in the extruded parts. Although the foaming was not well controlled, the parts were characterized as having a foam center and generally solid exterior surface.

FIGS. 1 and 2 depict extruded parts that were produced in Samples 1-5. Although they differ in the extent of foaming based on the particular compositions used, each extruded article 200 had a structured foam central portion 202 and micro foamed outer portion 204.

Samples for testing were typically obtained from the structured foam central portion 202 (IN) and micro foamed outer portion 204 (OUT) of each extruded sample. Typical densities of the various samples are shown in the table below.

| Sample | Density (g/cm³) |
|---|---|
| 1 IN | 0.59 |
| 1 OUT | 0.97 |
| 2 IN | 0.61 |
| 2 OUT | 1.02 |
| 3 IN | 0.57 |
| 3 OUT | 0.86 |
| 4 IN | 0.59 |
| 4 OUT | 0.79 |
| 5 IN | 0.60 |
| 5 OUT | 0.68 |

Flexural bending tests were conducted in accordance with ASTM D 790 “Standard Test Methods for Flexural Properties of Unreinforced and Reinforced Plastics and Electrical Insulating Materials” on samples from Samples 1-5. Modulus of Rupture (MOR) and Modulus of Elasticity (MOE) results appear in the following table (average value from 3-5 tests).

| Sample | MOR (psi) | MOE (psi) |
|---|---|---|
| 1 IN | 2,000 | 254,000 |
| 1 OUT | 3,700 | 435,000 |
| 2 IN | 1,300 | 174,000 |
| 2 OUT | 5,000 | 595,000 |
| 3 IN | 1,500 | 127,000 |
| 3 OUT | 3,000 | 291,000 |
| 4 IN | 1,100 | 111,000 |
| 4 OUT | 2,700 | 290,000 |
| 5 IN | 1,000 | 104,000 |
| 5 OUT | 1,400 | 151,000 |

The data show the excellent flexural strength and modulus properties of the extruded samples prepared according to the present invention.

Test samples were also obtained and evaluated according to ASTM D 638 “Standard Test Method for Tensile Properties of Plastics.” Dog bone specimens of ¾″ width and ½″ thickness were tested using a 2-kip INSTRON® Universal Tester (Instron Corporation, Canton, Mass.) at a rate of 0.2 inch/min. Modulus of Rupture (MOR) and Modulus of Elasticity (MOE) results appear in the following table (average value from 3-5 tests).

| | MOR | MOE |
|---|---|---|
| Sample | (kgf/cm²) | (kgf/cm²) |
| 1 IN | 60 | 24,250 |
| 1 OUT | 170 | 58,500 |
| 2 IN | 110 | 45,300 |
| 2 OUT | 160 | 65,800 |
| 3 IN | 120 | 14,700 |
| 3 OUT | 150 | 41,000 |
| 4 IN | 170 | 11,500 |
| 4 OUT | 120 | 32,600 |
| 5 IN | 110 | 12,500 |
| 5 OUT | 120 | 13,000 |

The data show the excellent tensile strength and modulus properties of the extruded samples prepared according to the present invention.

Samples from Samples 1-5 were evaluated for thermal expansion properties according to ASTM D 696 “Standard Method for Coefficient of Linear Thermal Expansion of Plastics Between −20° C. and 20° C.” Five samples (IN and OUT as described above) were cut from both the transverse axis (opposite axis of extrusion, X) and lateral axis (with the axis of extrusion, Y) having dimensions width 0.375″, height 0.375: and length 2.50″. The Coefficient of Thermal Expansion (CTE) i.e., the fractional increase in strain per unit rise in temperature is shown in the following table (average value from 3-5 tests).

| | CTE IN (in/° C.) | CTE OUT (in/° C.) |
|---|---|---|
| Sample | (×10⁻⁵) | (×10⁻⁵) |
| 1 X | 5.83 | 5.95 |
| 1 Y | 5.35 | 4.01 |
| 2 X | 5.86 | 6.15 |
| 2 Y | 5.49 | 4.17 |
| 3 X | 7.95 | 8.35 |
| 3 Y | 7.09 | 5.86 |
| 4 X | 7.95 | 7.66 |
| 4 Y | 6.28 | 4.995 |
| 5 X | 7.30 | 7.25 |
| 5 Y | 6.41 | 5.85 |

The data demonstrate the excellent thermal expansion properties of the extruded articles prepared according to the invention having CTE values ranging from 0.0000401 to 0.0000835 in/° C.

Samples from Samples 1-5 were evaluated for impact according to ASTM D 256 “Standard Test Methods for Determining Izod Pendulum Impact Resistance of Plastics.” The Izod Impact results are shown in the table below.

| Sample | IZOD Impact (J/m²). |
|---|---|
| 1 IN | 7.56 |
| 1 OUT | 12.86 |
| 2 IN | 8.55 |
| 2 OUT | 15.10 |
| 3 IN | 14.93 |
| 3 OUT | 28.12 |
| 4 IN | 13.94 |
| 4 OUT | 21.14 |
| 5 IN | 11.6 |
| 5 OUT | 15.43 |

The data demonstrate the excellent IZOD Impact properties of the extruded articles prepared according to the invention.

The present invention has been described with reference to specific details of particular embodiments thereof. It is not intended that such details be regarded as limitations upon the scope of the invention.

What is claimed is:

1. An article comprising a cellulosic fiber filled thermoplastic that includes:
a) about 10% to about 99.9% by weight of a copolymer formed by polymerizing a mixture comprising:
i) about 51% to about 99.9% by weight of one or more primary monomers,
ii) about 0.1% to about 49% by weight of one or more maleate-type monomers, and
iii) optionally about 1% to about 25% by weight of one or more other polymerizable monomers;
b) optionally about 0.1% to about 30% by weight of one or more elastomeric polymers; and
c) about 0.1% to about 70% by weight of one or more cellulosic fibers;
wherein the article has a thickness of from about 0.1 cm to about 35 cm;
wherein at least a portion of the article is foamed.

2. The article according to claim 1, wherein said foamed portion has a density of less than 1 g/cm³.

3. The article according to claim 1, wherein the tensile modulus, determined according to ISO 527-2, of the cellulosic fiber filled thermoplastic is at least 2,000 MPa; and
wherein the DTUL, determined according to ISO-75-2 at 1.82 MPa, of the cellulosic fiber filled thermoplastic is at least 85° C.

4. The article according to claim 1, wherein the primary monomers are selected from the group consisting of styrenic monomers and olefinic monomers and combinations thereof.

5. The article according to claim 4, wherein the styrenic monomers are selected from the group consisting of styrene, p-methyl styrene, a-methyl styrene, tertiary butyl styrene, dimethyl styrene, nuclear brominated or chlorinated derivatives thereof and combinations thereof.

6. The article according to claim 1, wherein the maleate-type monomers are selected from the group consisting of maleic anhydride, maleic acid, fumaric acid, acrylic acid, methacrylic acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

7. The article according to claim 1, wherein the elastomeric polymers are selected from the group consisting of homopolymers of butadiene or isoprene; random, block, AB diblock, or ABA triblock copolymers of a conjugated diene with a styrenic monomer and/or acrylonitrile; ABS; copolymers of C₁-C₁₂ linear, branched or cyclic olefins and C₁-C₁₂ linear, branched or cyclic alkyl esters of (meth)acrylic acid, diblock and triblock copolymers of styrene-butadiene, styrene-butadiene-styrene, styrene-isoprene, styrene-isoprene-styrene, partially hydrogenated styrene-isoprene-styrene and combinations thereof.

8. The article according to claim 1, wherein the other monomers are one or more selected from the group consisting of divinylbenzene, conjugated dienes, alkyl methacrylates, alkyl acrylates, acrylonitrile, and combinations thereof.

9. The article according to claim 1 comprising one or more additives selected from the group consisting of heat stabilizers, light stabilizers, plasticizers, dyes, pigments; anti-blocking agents; slip agents; lubricants; coloring agents; antioxidants; ultraviolet light absorbers; fillers; anti-static agents; impact modifiers, and combinations thereof.

10. The article according to claim 1, wherein the weight average molecular weight of the copolymer is from about 20,000 to about 1,000,000.

11. The article according to claim 1, wherein the cellulosic fibers include one or more selected from the group consisting of hardwood fiber, kenaf fibers, wheat fibers, rice hulls, hemp fibers, jute fibers, flax fibers, ramie fibers, softwood fibers, hardwood pulp, softwood pulp, wood flour, pelletized recycled paper, and combinations thereof.

12. The article according to claim 1, wherein the cellulosic fibers have a diameter of at least 0.1 μm.

13. The article according to claim 1, wherein the cellulosic fibers include wood flour and/or wood fibers.

14. A method of making the article according to claim 1 comprising:
a) optionally combining the copolymer and elastomeric polymers to form a compounded copolymer;
b) combining the cellulosic fibers with the copolymer and/or compounded copolymer to form a cellulosic compounded copolymer; and
c) extruding the cellulosic compounded copolymer to form an extruded article.

15. The method according to claim 14 wherein the copolymer and elastomeric copolymer are combined by melt blending.

16. The method according to claim 14 wherein the copolymer and/or compounded copolymer and cellulosic fibers are combined by melt blending.

17. A fence comprising the article according to claim 1.

18. A decking system comprising the article according to claim 1.

19. A wall comprising the article according to claim 1.

20. A roof system comprising the article according to claim 1.

21. A structure comprising the article according to claim 1.

22. A building comprising the article according to claim 1.

23. A boardwalk comprising the article according to claim 1.

24. A railing comprising the article according to claim 1.

25. The article according to claim 1, wherein the cellulosic fiber filled thermoplastic is compounded or otherwise blended with one or more other polymers to form a cellulosic fiber filled thermoplastic blend.
